(19) United States
(12) Patent Application Publication
(10) Pub. No.: US 2012/0056140 A1
(43) Pub. Date: Mar. 8, 2012

(54) Concrete sidewalk slab lifter

(76) Inventor: Lavonne O'Gwynn, Port Orange, FL (US)

(21) Appl. No.: 13/199,637

(22) Filed: Sep. 6, 2011

Related U.S. Application Data
(60) Provisional application No. 61/381,049, filed on Sep. 8, 2010.

(51) Int. Cl. B66D 1/60; B66D 1/12; B66D 1/00

(52) U.S. Cl. 254/362; 254/266

(57) ABSTRACT

A concrete sidewalk section raising apparatus is provided for pivoti-lifting one side thereof to permit leveling of the ground beneath without the necessity of destroying the concrete section, and to permit it to be lowered intact once the underlying ground is properly leveled. An A-frame support stand supports a motorized winch and cable to raise one side to about 45° from the vertical.

This application claims the benefit of a provisional application, No. 61/381,049 filed Sep. 8, 2010.

This invention relates to the remediation and repair of uneven concrete sidewalks, more particularly, to accessing the underlying cause of displacement of a sidewalk section while conserving the displaced slab.

### BACKGROUND OF THE INVENTION

Municipalities and homeowners' associations are tasked with maintaining sidewalks for pedestrian traffic that are evenly graded and continuous, without interruptions that could trip a person. When sections of sidewalk are thrust out of alignment by tree roots, or by settling of the underlying earth, the traditional approach to remove the hazard has been to break up the displaced section with a jackhammer, and then to haul the debris off site to a landfill, and after leveling the underlying earth, building a form and pouring a new concrete slab. This process is expensive in terms of manpower, equipment, materials, transport and environmental impact.

Thus it is an object of this invention to provide a simple means of pivoting one side of displaced concrete sidewalk section upwards through an angle of at least 45° so that a single worker can remove offending tree roots or add soil, so as to level the underlying ground, and then lower the section back to its desired position, thereby obviating all the expenses of destruction of the slab and pouring of a new slab. Another object of the invention is to provide a simple, relatively inexpensive and stable stand to support a winch and cable system with attached weight, thereby enabling a single worker to raise and lower one side of a displaced sidewalk section through an angle of at least 45°. Still another object of this invention is to provide a device that is easily collapsed for transport and storage.

### PRIOR ART

U.S. Pat. No. 5,833,430 to Reynolds shows a mast-winch-and pulley device for pivot-lifting a wall frame from a horizontal position to a permanent vertical position. In operation, the mast tilts toward the wall frame from the mast's starting vertical position, while the edge of the wall frame nearest the mast elevates, while the opposite edge remains on the ground. Lumber available at the construction site is utilized in the mast device.

U.S. Pat No. 5,970,680 to Powers is for a method and apparatus for raising concrete floor slabs to form a multi-floor structure, using an air cushion to lift the slabs.

U.S. Pat. No. 5,867,950 discloses a very complicated device for lifting a framework or building portion. It is designed to be used together with a plurality of like devices distributed around the framework, to achieve proper orientation.

U.S. Pat. No. 7,213,380 to Justice shows a wheeled carrier for permanently removing a concrete floor, sections by section. It employs leverage to pry up an entire section and place it on the carrier for removal.

U.S. Pat. No. 6,694,679 to Verna is for a safety stand for holding a heavy slab of material at a small angle from a vertical position, in preparation for being lifted.

None of the above-referenced inventions provides the objects of the present invention.

### SUMMARY OF THE INVENTION

A concrete sidewalk section raising apparatus is provided for pivot-lifting one side thereof to permit leveling of the ground beneath without the necessity of destroying the concrete section, and to permit it to be lowered intact once the underlying ground is properly leveled. An A-frame support stand supports a motorized winch and cable to raise one side to about 45° from the vertical.

### BRIEF DESCRIPTION OF PREFERRED EMBODIMENTS

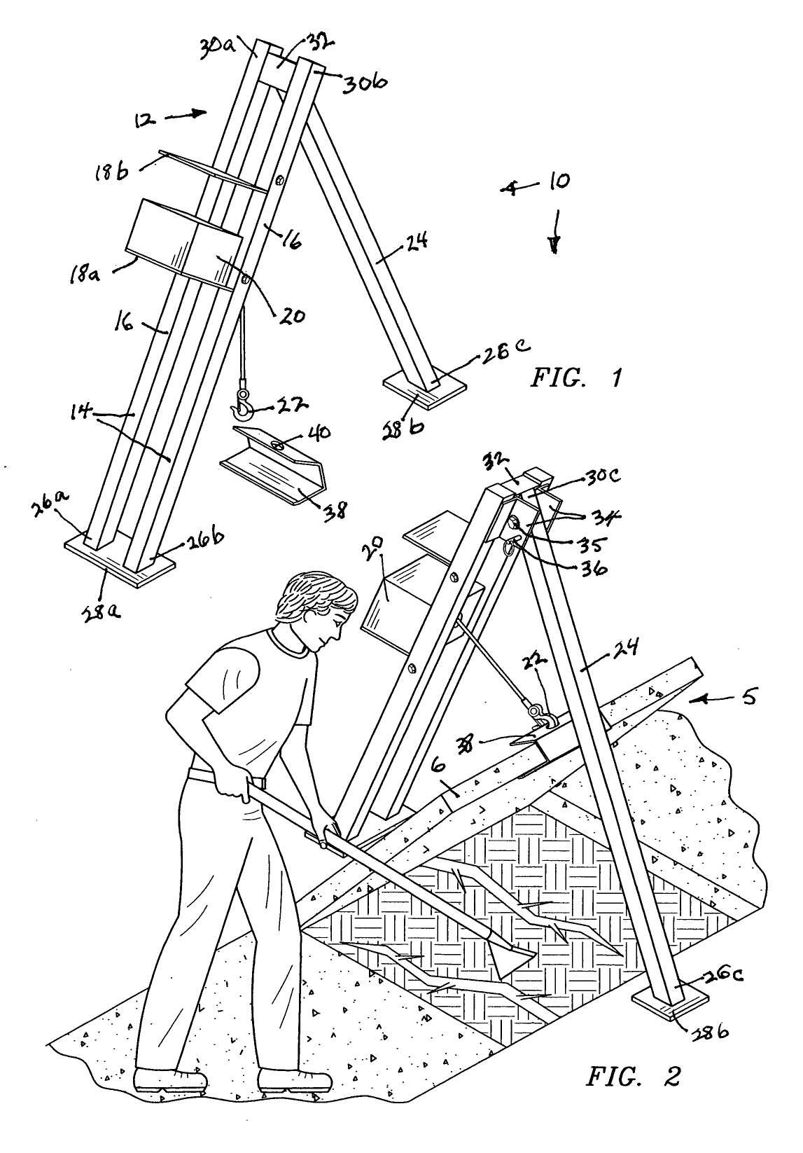

FIG. 1 is a perspective view of one side of a concrete slab raising apparatus that embodies the invention;

FIG. 2 is a perspective view of the opposite side of the invention having pivoted one side of a slab upward.

### DETAILED DESCRIPTION OF THE PREFERRED EMBODIMENTS

The apparatus shown in the drawings and described below is an example which embodies the invention, but does not limit the scope of the invention, which is defined by the accompanying claims.

Referring now to FIGS. 1 and 2, the slab-raising device 10 shown comprises an A-frame stand 12. Leg 14 of stand 12 preferably comprises a pair of beams 16 with attached shelf or shelves 18a and b, for supporting a motorized winch-and-cable system 20 with hook 22. A hand-operated winch could possibly be substituted for a motor-driven system. Another possibility would be to suspend a block-and-tackle system with a mechanical advantage of 4 to 6 from the apex of the A-frame. This should be workable with slabs weighing 500 lb. or less. The lower shelf 18a is used for lifting a sidewalk section 5 of approximate 4 feet in width, and the upper shelf 18b is designed for a slab approximately 5 feet wide. Leg 24 of stand 12 can be a single beam. Preferably beams 16 and 24 are made of 2-by-2 inch square aluminum tubing. The lower ends 26a, b, b of legs 14 and 24 are preferably welded to flat base plates 28a and b, at angles permitting legs 14 and 24 to form the A-shape of stand 12. They are joined at their upper ends 30a, b and C at a connector 32 affixed between beams 16, and by a pair of L-shaped members 34 connected on either side of leg 24 with a single through-bolt 35 allowing leg 24 to pivot to a position proximate to leg 14, thereby collapsing the A shape of stand 12 for ease of storage and transport. To hold the A shape open and prevent pivoting while stand 12 is in use, a removable pin 36 is provided which extends through L-shaped members 34 and upper end 30c of leg 24. A separate three-sided slab holder 38, preferably of steel, has an aperture 40 for insertion of hook 22 of the winch-and-cable system 20.

In operation, the slab-raising device is placed astride over the section of sidewalk to be raised. In many cases this section must be severed from adjoining sidewalk sections with a concrete saw, creating a rectangular slab 5 The slab holder 38 is placed around the middle of side 6 of slab 5 nearest leg 24, as shown in FIG. 2. Hook 22 is inserted in aperture 40, and the winch is then operated to raise side 6 to an angle of approximately 45°. A temporary safety chain, not shown could be clamped at one end to side 6 and at the other end to leg 14 to prevent slab 5 from moving, while leveling of the underlying ground is completed. The chain would be removed, and then the slab would be lowered by reversing the rotation of the winch.

I claim:

1. Apparatus for pivot-lifting a concrete slab to a position at least 45° above horizontal, comprising:
A removable slab bracket adapted to fit around one edge of a concrete sidewalk section, having an aperture for engaging a lifting element;
A lifting element including a cable member with an attached grasping member for removably attaching the cable to the slab bracket;
A pulling element having a mechanical advantage of at least 4:1, connectable to said lifting element;
A support stand comprised of a pair of legs in an A-frame configuration capable of supporting the lifting element and the pulling element while raising one side of a concrete sidewalk section

2. The apparatus of claim 1, wherein each leg has an upper end and a lower end, said upper ends pivotably connected to each other by a fastener-set of elements, the fastener set including a removable pin member to hold the legs open in the A-frame configuration

3. The apparatus of claim 2 wherein the lower end of each leg is affixed to a stabilizing base plate.

4. The apparatus of claim 3 wherein the pulling element is a winch.

5. The apparatus of claim 4 further comprising a plurality of holders for supporting said winch at a plurality of selected positions between the upper and lower ends of one of the legs of the support stand and over the sidewalk section to be raised

6. The apparatus of claim 5 wherein said winch is powered by an electric motor.

7. An apparatus for pivot-lifting of one side of a section of concrete sidewalk, comprising
a slab bracket for removably engaging the side to be lifted, the bracket including an aperture;
a cable element with grasping hook for engaging said aperture;
a motorized winch for winding said cable element;
an A-framed support stand comprised of a pair of legs configured to straddle the concrete sidewalk section to be raised, and supporting said winch on any one of a plurality of winch holders spaced along one leg of the stand and above said sidewalk section, said legs having upper and lower ends, pivotably connected at their upper ends with a fastener-set of elements including a removable pin to hold the legs in their A-framed configuration.
